(19) United States
(12) Patent Application Publication
(10) Pub. No.: US 2018/0184691 A1
(43) Pub. Date: Jul. 5, 2018

(54) CONCENTRATED FRUIT JUICE FOR A MARINADE

(71) Applicant: Hama Foodservice GesmbH, Hof bei Salzburg (AT)

(72) Inventors: Rudolf HAINDL, Salzburg (AT); Hans MANDL, Pfunds (AT)

(73) Assignee: Hama Foodservice GesmbH, Hof bei Salzburg (AT)

(21) Appl. No.: 15/738,450

(22) PCT Filed: Jun. 23, 2016
(86) PCT No.: PCT/AT2016/050222

§ 371 Date: Dec. 20, 2017

(30) Foreign Application Priority Data
Jun. 24, 2015 (AT) A 50543/2015

(51) Int. Cl. A23L 2/08; A23L 19/00; A23L 13/70; A23L 13/00

(52) U.S. Cl. CPC A23L 2/08; A23L 19/09; A23V 2002/00; A23L 13/06; A23L 13/72

(57) ABSTRACT

The invention relates to concentrated fruit juice for a marinade for tumbling a meat product, the weight percentage of sorbitol in the concentrated fruit juice being more than 10 wt.-%. The concentrated fruit juice contains at least concentrated pear juice, concentrated mirabelle juice and/or concentrated quince juice.

The invention relates to a concentrated fruit juice for a marinade for tumbling a meat product, the proportion of sorbitol in the concentrated fruit juice being more than 10 percent by weight. The invention also relates to a process for producing such a concentrated fruit juice as well as the use of a concentrated fruit juice of this type in a marinade for tumbling a meat product. Furthermore, the invention relates to a marinade for tumbling a meat product, with the ingredients water, salt, gelatine, milk-based ingredient and such a concentrated fruit juice.

The production of foodstuffs, in particular meat products, is becoming more and more automated. Although, initially, intensive livestock farming was mainly responsible for the continuous fall in the price of meat, what is important nowadays is no longer just to offer as cheap a piece of meat as possible, but also to carry out in advance some of the further processing steps originally carried out by the consumer or the user. Thus, for a long time it has been customary to place the meat or pieces of meat in a marinade. Additional flavourings are thereby already added to the meat. In addition, the shelf life can also be influenced positively. Moreover, a marinated piece of meat is appealing for a consumer.

So-called tumbling has long been accepted for industrial marinating, particularly among bulk producers. The meat or the pieces of meat are rotated in a large tumbling device together with the marinade, whereby the marinade (sauce) is absorbed even better into the meat. For producers, this has the additional advantage, in addition to the improvement in flavour and the increase in shelf life, of an increase in weight, whereby a higher price can be achieved with a lower meat content. To increase the weight as much as possible, phosphates have been used for a long time. These are used in the production of sausages, the production of ham and in tumbling meat applications. The use of phosphate serves to improve the water-binding capacity and the texture and tenderness of the end product.

While the addition of salt in the preparation of fresh meat is primarily for flavouring, the essential function of phosphate salts in meat products is the absorption of liquid in the meat product. Because of the higher antioxidant content, an increase in shelf life is also achieved. The use of phosphate in meat processing is increasingly being challenged, which is why the question of possible alternatives is being raised more and more often. Phosphates, as an additive containing E numbers, and being associated with phosphate intolerances and osteoporosis in humans, have a dubious reputation among some nutrition experts and consumers. For these reasons, the aim has long been to replace phosphate completely while achieving largely the same results. For this purpose, various products, such as transglutaminase, have already been tested in place of phosphate, but with little success.

In order to be able to dispense with the use of phosphate and nevertheless achieve a good tumbling result (improvement in flavour, increase in shelf life, increase in weight, less cooking shrinkage, more tender meat), a marinade for tumbling a meat product is known from the not previously published Austrian patent application AT 515 254 A1. In the case of this marinade, among other things, a fruit extract (synonymous with concentrated fruit juice) is used in the form of a plum extract (concentrated plum juice or concentrated damson juice).

In principle there are already various concentrated fruit juices from other categories. For example, a method for reducing the saccharide content in concentrated juices is known from WO 2015/014490 A1. The source of these concentrated juices is a pressing of apple, pear, raspberry, mirabelle plums, apricots, carrots etc. A concentrated fruit juice is revealed by WO 2012/167872 A1, which uses, as fruit component, passionfruit, peaches, plums, mandarins, mirabelle plums, olives, pears, pumpkins, quinces or star fruit, for example. A similar product is also revealed by WO 2015/000580 A2. However, these texts, which are from other categories, all describe concentrated fruit juices which are used as the starting basis for the production of drinkable fruit juices and thus as the basis for drinks.

In contrast, in the case of AT 515 254 A1, which defines the category, the concentrated fruit juice is used to improve the properties of the marinade. The increased proportion of sorbitol (15% to 20%) in the plum extract mentioned in AT 515 254 A1, in interaction with the milk protein of the milk-based ingredient or the cream and the gelatine, means that this marinade acts as an effective humectant which can cause water to bind. A further advantage of plum extract is the improved browning during roasting.

A number of problems have now arisen in connection with this concentrated plum juice as a possible important constituent of a marinade for tumbling a meat product. One problem is that it is difficult to keep the Californian dried plums usually used as starting product for concentrated plum juice (these are usually Prunus domestica subsp. domestica or Prunus domestica subsp. insititia or Prunus domestica subsp. intermedia or Prunus domestica subsp. prisca) at a consistent quality for a long period of time. Furthermore, it is difficult to obtain a sufficient quantity of plums over a long period of time. In addition, the preferred plums are mainly grown in California, which means relatively expensive transport to Europe. Moreover, because this is the single sufficiently large producing area worldwide for these specific dried plums, there is a relatively high risk of crop losses. This means that, if there is an inadequate harvest in California, or even a crop failure, prices increase sharply or there may even be insufficient production of concentrated plum juice. In the case of a poor harvest, the sorbitol content can also be too low.

The object of the present invention is, therefore, to avoid the above-named disadvantages and to provide an alternative and improved concentrated fruit juice.

This is achieved by a concentrated fruit juice with the features of claim 1. Accordingly, it is provided according to the invention that the concentrated fruit juice contains at least a concentrated pear juice, a concentrated mirabelle plum juice and/or a concentrated quince juice. Thus, the previously used concentrated plum juice can be replaced as ingredient for a marinade for tumbling a meat product. In particular, this replacement concentrated fruit juice has the same advantageous marinating and cooking properties as the plum concentrate, but, at the same time, the above-named risks and disadvantages in growing and in procurement can be reduced. Since pears, mirabelle plums (Prunus domestica subsp. syriaca) and quinces are grown in large quantities in different producing areas (including in Europe), a consistent quality and the procurement of sufficient quantities can be better guaranteed. There is no risk of fluctuations as in the case of the Californian dried plums. In addition, the desired sorbitol content of above 10 wt.-% of the concentrated fruit juice as ingredient in the marinade is also achieved with these types of fruit, whereby, when used in a marinade, water binding is increased, and browning is improved.

In order to achieve better balance and lower dependence on individual types of fruit, it is preferably provided that the concentrated fruit juice contains at least two of the concentrates concentrated pear juice, concentrated mirabelle plum juice and concentrated quince juice. It is particularly preferably provided that the concentrated fruit juice contains a mixture of concentrated pear juice, concentrated mirabelle plum juice and concentrated quince juice. Through such a mixture of three types of fruit, the production of the concentrated fruit juice can be better adapted to the availability and the prices of the individual types of fruit. Fluctuations in the procurement costs and in quality are thereby minimized.

In principle, for greater independence from concentrated plum juice it can be provided that the proportion of at least one, preferably two, particularly preferably all three of the concentrates concentrated pear juice, concentrated mirabelle plum juice and concentrated quince juice in the concentrated fruit juice is more than 20 wt.-%. This enables the composition of the concentrated fruit juice to be adapted to the current market conditions.

In particular, if the concentrated fruit juice contains a mixture of the concentrates mentioned it is preferably provided that the concentrated fruit juice consists up to at least 75%, preferably up to at least 90%, of a mixture of concentrated pear juice, concentrated mirabelle plum juice and concentrated quince juice. The remaining proportion of the concentrated fruit juice can be produced, for example, on the basis of apples, apricots, papayas, rowan berries, plums and/or peaches etc. In order, however, to guarantee as consistent as possible a quality and, above all, a consistent flavour, it is preferably provided that the concentrated fruit juice consists up to 100% of a mixture of concentrated pear juice, concentrated mirabelle plum juice and concentrated quince juice. The mixed concentrated fruit juice thus consists of only these three types of starting fruit.

The proportion of the individual concentrates in the whole concentrated fruit juice can vary. For example, the proportion of concentrated pear juice in the concentrated fruit juice is preferably between 1 and 33.3 wt.-%, preferably between 10 and 30 wt.-%, particularly preferably is 26 wt.-%. In addition, the proportion of concentrated mirabelle plum juice in the concentrated fruit juice can be between 1 and 43.3 wt.-%, preferably between 15 and 42.5 wt.-%, particularly preferably is 41.4 wt.-%. Moreover, the proportion of concentrated quince juice in the concentrated fruit juice is between 1 and 40 percent by weight, preferably between 10 and 35 wt.-%, particularly preferably is 32.6 wt.-%. In the preferred composition, the concentrated fruit juice thus contains a mixture of 26 wt.-% concentrated pear juice, 41.4 wt.-% concentrated mirabelle plum juice and 32.6 wt.-% concentrated quince juice.

Depending on the quality and ripeness of the starting fruit, the sorbitol content in the concentrated fruit juice can fluctuate slightly. However, the proportion of sorbitol in the concentrated fruit juice is preferably more than 11 wt.-%, preferably between 12 and 14 wt.-%.

Protection is also sought for a process for producing a concentrated fruit juice according to the invention. Thus, the steps are provided of depositing a fruit pulp made of pears, mirabelle plums and/or quinces onto a base, evaporating the water contained in the fruit pulp until the concentrated fruit juice forms, preferably with a concentration of more than 500%, and filling the concentrated fruit juice into containers.

For the process for producing the concentrated fruit juice, as far as possible only high quality, ripe fruits of the respective types, without any damage or decay, are processed. The fruit juice or pure juice (e.g. 100 kg minus 6.4% dry solids) is produced in special centrifuges, preferably under vacuum, by gentle pressing. In the further process, ultrafiltration is used. A reverse osmosis process, for example using a spiral fibre module at 1 to 10 bar, can also be used. Substances such as monosaccharides and disaccharides can thus be eliminated from the solution to be concentrated, which has the benefit of a higher concentration of the flavour components.

The fruit pulp made of pear, mirabelle plum and/or quince prepared in this way is then poured onto bases in the form of flat metal sheets to produce the actual concentrated fruit juice. On these bases, the fruit pulp is placed into a short-time evaporator (e.g. from Alfa Laval). Therein, water is evaporated out of the fruit pulp at a nominal output of, for example, 50 kg per hour. By lowering the pressure (reduced pressure of 70,000 to 95,000 Pascal), the water already evaporates at temperatures below 100° C. The evaporated water is suctioned off by pumps. In particular, the desorbed water is largely pumped off by turbomolecular pumps during the heating, likewise any hydrocarbon contaminations present. As a result of the lower evaporation temperatures, the flavours and nutritional values in the concentrated fruit juice are almost completely retained. Thus, substances such as monosaccharides or disaccharides can also be eliminated from the solution to be concentrated, for example. The concentration of the flavour components can thereby achieve a concentration factor of 10 to 30 times.

The filling of the concentrated fruit juice can finally take place into containers or storage containers, such as, for example, into 100- to 200-kg barrels. These can be stored refrigerated for approx. 3 months and deep-frozen for approx. 9 to 10 months.

In the case of the production of concentrated fruit juice it is usual per se to concentrate the original fruit pulp by 5 to 7 times. In particular, transport can thereby be simplified. Conversion back into a fruit juice then takes place at the desired location through the addition of corresponding quantities of water. Specifically, the preferred concentration factor is 5.9%.

In particular, protection is also sought for the use of a concentrated fruit juice according to the invention as an ingredient in a marinade for tumbling a meat product. Preferably, the concentrated fruit juice—and not a reconverted fruit juice—is admixed to the marinade.

Moreover, protection is also sought for a marinade for tumbling a meat product, wherein the marinade contains as ingredients water, salt, gelatine, m ilk-based ingredient, preferably cream, and a concentrated fruit juice according to the invention, which has at least a concentrated pear juice, a concentrated mirabelle plum juice and/or a concentrated quince juice. Particularly preferably, for an appropriate flavour, for sufficient water binding and for good browning properties, it is provided that the proportion of concentrated fruit juice in the marinade is between 3 and 10 wt.-%, preferably between 5 and 8 wt.-%. To produce the marinade, it is important that a concentrated fruit juice with the appropriate sorbitol content is added. The way in which the concentrated fruit juice enters the marinade is irrelevant per se. Thus, it can certainly be provided that one or more concentrates are produced individually, in that, for example, a pure concentrated pear juice, a pure concentrated mirabelle plum juice and a pure concentrated quince juice are produced separately. These concentrates can then be added to the remaining ingredients individually and according to the desired composition as late as during the production of the marinade. However, it is preferably provided that a mixed concentrate of pears, mirabelle plums and quinces is produced at the same time and this is then added as a whole to the remaining ingredients during the production of the marinade.

In a marinade of this type, the milk protein contained in the milk-based ingredient binds the water particularly well. The same applies to the gelatine. Since these additional ingredients have a relatively neutral flavour, they can be used particularly well as an ingredient for a marinade. A further advantage of these ingredients is the low cooking shrinkage after the tumbling. Furthermore, in contrast to phosphate, these ingredients are pure natural products.

The marinade preferably contains starch (polysaccharide) as a further ingredient. This starch contained in the marinade serves above all to coat the meat product. The pores are thereby sealed particularly well, and a lower cooking shrinkage is thus achieved. The starch is particularly preferably produced on the basis of maize.

A sour milk product, such as for example yoghurt, can be used as milk-based ingredient. However, it is preferably provided that cream (sweet cream) is used as milk-based ingredient.

In addition, the marinade can contain a rosemary extract. Above all, this extract helps with shelf life and improved flavour. The rosemary extract additionally reduces the susceptibility to mould.

The mixing ratio of the ingredients present should be chosen at least such that the marinade can be used readily and that there are no extreme flavours. It is preferably provided, therefore, that the proportion of water is between 50 and 80 wt.-%, preferably between 60 and 70 wt.-%. In particular, the proportion of water is approx. 65 wt.-%. Of course, it is to be mentioned here that water is also contained in the other ingredients (above all in the cream). However, the latter wt.-% proportion is not meant here, only the water content which is added at the start as pure water when mixing the ingredients together.

Furthermore, it is preferably provided that the proportion of salt is between 1 and 6 wt.-%, preferably between 2 and 3.5 wt.-%. In the specific case, the salt content is 2.78 wt.-%. In this context, by salt is meant kitchen salt, cooking salt or table salt, which consists predominantly of sodium chloride. In the marinade, the salt not only helps the flavour, but it also opens up the meat protein with the result that the marinade can better penetrate the meat as a whole.

According to a further preferred embodiment example, it is provided that the proportion of starch is between 1 and 5 wt.-%, preferably between 1.5 and 3 wt.-%. In the specific case, the proportion of starch is 2.17 wt.-%.

If the proportion of concentrated fruit juice is between 3 and 10 wt.-%, preferably between 5 and 8 wt.-%, the absorption of liquid is particularly good. In the preferred case, the proportion of concentrated fruit juice is 6.47 wt.-%. In other words, the proportion of sorbitol in the marinade as a whole is thus at least 0.3 percent by weight.

The proportion of rosemary extract in the marinade as a whole can be kept quite low. It is thus less than 0.01 wt.-%, for example. In the specific case, the wt.-% proportion can be 0.0046%. However, the marinade can also contain no rosemary.

Since the cream and the gelatine have proven to be a particularly good replacement for the phosphates during tumbling, it is preferably provided that the proportion of cream and gelatine together is 15 and 30 wt.-%, preferably between 20 and 25 wt.-%. The proportion of cream and gelatine is particularly preferably 23.48 wt.-%. Cream and gelatine also have a preferred wt.-% ratio relative to each other. It is provided that the ratio of cream to gelatine is between 99.5 to 0.5 and 97 to 3. As a specific value, the gelatine can be 1.76 wt.-% of the total mixture of cream and gelatine. Correspondingly, the wt.-% proportion of the cream is 98.24 wt.-%. The cream is itself in turn an emulsion of milk fat in water. It is preferably provided that the proportion of milk fat in the cream is between 12 and 18 wt.-%, preferably between 13.5 and 16.5 wt.-%. In the specific case, the cream has a milk fat content of 15%.

A lactose-free cream can also be used as cream. This means that the cream contains no milk sugar (lactose), or only a very small proportion (less than 0.1 gram per 100 grams milk or cream) of it. This lactose-free cream can be produced by adding an enzyme (lactase) in the production process, which breaks the milk sugar down into galactose and grape sugar (glucose).

Protection is sought not only for the marinade but also for a process for producing a meat product by tumbling. The steps are provided of chopping up the meat into pieces of meat, introducing the chopped-up pieces of meat into a tumbling device, introducing a marinade according to the invention into the tumbling device with the chopped-up pieces of meat and tumbling the pieces of meat in the marinade by rotating the tumbling device. Through this process, a very good tumbling result can also be achieved without the use of phosphate.

In this process, it can preferably be provided that the wt.-% ratio of pieces of meat to marinade is between 70 to 30 and 95 to 5. In the specific case, this wt.-% proportion of the meat is 80.97%, whereas the wt.-% proportion of the marinade is 19.03%. Depending on the pieces of meat or type of meat used, the wt.-% proportion of the marinade used can, of course, also vary quite widely. The pieces of meat can originate from the most varied types of animals. Thus, for example, beef, pork, chicken and turkey meat, but also fish, meat from crustaceans or shellfish (e.g. mussels) etc. can be used.

For a particularly good absorption it is provided that the tumbling is carried out in the tumbling device at a vacuum of at most 85%.

Depending on the type of the meat used and depending on its basic absorption capacity, it is preferably provided that the tumbling is carried out in the tumbling device for 25 to 100 minutes.

During the production and during the tumbling, the marinade can per se be as cold or warm as desired. However, it is preferably provided that the marinade is introduced into the tumbling device at a temperature of from 3 to 5° C.

Obviously, the starting product used as meat should be of particularly good quality. It is therefore preferably provided that the pH of the pieces of meat is between 5 and 8, is preferably 7.

In order to guarantee that the marinade penetrates the pieces of meat well but that the tumbling still does not cause too much damage in the pieces of meat, it is preferably provided that the tumbling device rotates at 5 to 21 rotations per minute during tumbling.

However, protection is not only sought for the marinade and for a tumbling process but also for a meat product with at least one piece of meat and a marinade according to the invention absorbed in the piece of meat. Of course, the marinade does not have to be entirely absorbed in the piece of meat, but it can also partly surround the at least one piece of meat.

Since it is not just the marinade alone that has an important influence on the tumbling, the following yet further aspects which are important for the invention are also mentioned.

The meat structure is an important basis for phosphate-free tumbling. This is determined by a plurality of processes and starting conditions, such as the age of the animal, the type of animal, the rate of chilling after slaughter, the final pH and the duration of maturing. All of these points have an influence on the final result.

Particularly important points in the application of the marinade according to the invention are the absorption of liquid and the cooking shrinkage. In test series with the marinade according to the invention it has been possible, without phosphates, to achieve standard criteria or even to improve on these in terms of the absorption of liquid and cooking shrinkage. In practice, increasing the shelf life is also important for retail chains and restauranteurs and was therefore taken into consideration in development. Specifically, the best conditions were achieved with the following composition:

| | | | Proportion in | Proportion in |
|---|---|---|---|---|
| | | | percent | percent |
| | | | by weight of | by weight of |
| Ingredient | Quantity | | the total quantity | the marinade |
| Quantity of meat | 13 | kg | 80.97% | |
| Water | 1.98 | kg | 12.39% | 65.07% |
| Cream + gelatine | 0.717 | kg | 4.47% | 23.48% |
| Salt | 0.085 | kg | 0.53% | 2.78% |
| Rosemary extract | 0.0014 | kg | 0.00087% | 0.0046% |
| Concentrated fruit | 0.197 | kg | 1.23% | 6.47% |
| juice | | | | |
| Maize starch | 0.066 | kg | 0.41% | 2.17% |

In addition to the condition of the meat and in addition to the basic composition, further aspects are also important. These are explained in more detail below:

Through the use of a marinade with cream and gelatine, the phosphate-free use of the marinade is supported. Specifically, the cream and the gelatine can be used in the form of a food product, as is known for example from EP 0 805 629 B1. Through such a marinade, the tenderness and the succulence of the pieces of meat are improved. In addition, the marinade can also be used whey protein, plant fibres (lemon fibres, plum fibres, pear fibres, mirabelle plum fibres, quince fibres etc.), starches, fruit flavouring extracts (e.g. the powder of dried types of fruit or types of herbs).

In comparison examples, phosphate brine was also used in the marinade. Above all, when this was added in too large a dose, this led to a rubber-like texture of the pieces of meat. This phenomenon could not be detected in the case of the marinade according to the invention.

When using the marinade with the pieces of meat in known tumbling devices (e.g. Vacuum Marinater or Turbo Tumbler), which have vacuum systems with up to 95% vacuum, care is to be taken that the vacuum does not exceed 82 to 83% during tumbling. No significant improvements in products could be detected below and above this. A duration of the tumbling process of between 30 and 95 minutes (depending on the size of the pieces) should be sufficient. Longer periods of time did not achieve any positive changes in the result. The rotational speed of the blade during the massaging in of the marinade into the pieces of meat should be 5 to 21 rotations per minute. If the speed is too high, the medium is chopped up too small and loses its natural appearance and shape.

The temperature of the marinade is preferably 3 to 5° C. The use of frozen meat is not to be recommended. The pH of the meat products should lie in the neutral range at a pH of 7. If the pH is below this (pH of 5), it can be assumed that the quality of the meat is not particularly suitable for tumbling.

After the vacuum process, it is expedient to allow the treated meat, divided into smaller or larger portions, to mature for 24 hours in a cold store at 3 to 5° C. The meat should be as dry as possible on the outside before the roasting process so that the loss of liquid during browning of the pieces of meat is reduced and is more efficient.

In the marinade, raw materials are used which, due to their high antioxidant content, are first of all a natural ingredient and guarantee for producers microbiological safety during processing and storage of raw or pre-cooked meat products. In addition, it is possible to provide protection against undesired flavours resulting from re-heating and keeping warm of products with a high fat content.

Because of the natural content of antioxidants, the marinade according to the invention can be used to increase the shelf life of meat products. The antioxidants inhibit the rancidification of unsaturated fatty acids in raw or pre-cooked meat products. In addition, the antioxidants effectively suppress the growth of pathogens such as Salmonella, E. coli bacteria and Listeria. In addition, through the natural content of sorbitol, water binding is strengthened, which is reflected in a succulent flavour and reduces the loss of juice during cooking.

Meat which has been subjected to a tumbling process to absorb liquid is usually subsequently heated. One of the most important reasons for the heating (in addition to flavour and tenderness) is the eradication of any microorganisms present. These are inactivated at a temperature of 55° C. Therefore, according to HACCP specifications, meat is heated to a core temperature of 75° C. in order to be completely safe.

Meat which is heated loses more and more liquid (water) and fat as the heating increases. In the case of sustained heating above 100° C., up to 48% cooking shrinkage can occur. Depending on the types of meat, the cooking shrinkage is also more or less dependent on the pH.

During the heating, the myofibrillar proteins shrink first of all. The connective tissue denatures from approx. 60 to 75° C. Since the shrinkage means water is being pressed out of the fibrillar structures, which immobilize approx. 85% of the water of the muscle, more and more water escapes from the meat at these temperatures. In the case of shrinkage, the meat normally becomes tougher; it is therefore important to pre-treat the meat structure (protein) in order to reduce this effect or even to eliminate it completely.

By massaging in the marinade according to the invention compared with traditional phosphate mixtures, no difference was detected in sensory test series in the handling of the meat sample.

In a specific test, chicken was tumbled for 45 minutes in a tumbling device at a vacuum of 82%, on the one hand, in a marinade according to the invention and, on the other hand, in a marinade with phosphate. After a period of 30 minutes, the increase in weight in the case of both marinades was approx. 13%. After 45 minutes, the increase in weight in the case of the marinade according to the invention was 17.95%, while with the phosphate it was 30.73%. Afterwards, this chicken was roasted for three hours at a core temperature of 65° C. In the case of the marinade according to the invention, the loss in weight was only 7.5%, while with the phosphate marinade it was 15.72%.

The same process was also carried out using veal. After 45 minutes, the increase in weight here in the case of tumbling of the marinade according to the invention was 23.13%, while with the phosphate marinade it was 25.32%. The cooking shrinkage was particularly low in the case of the marinade according to the invention compared with the phosphate marinade. This was 20.59% compared with 30.67% in the case of the phosphate marinade.

The same tumbling and the same roasting process was also carried out with pork. In the case of the marinade according to the invention, the increase in weight was 15.58%, while with the phosphate marinade it was 28.57%. Here too, the cooking shrinkage was significantly better with the marinade according to the invention. This was only 18.92%, while with the phosphate marinade it was 24.11% after roasting for three hours at a core temperature of 65° C.

The cell structure of meat and fish is very delicate, which is why high temperatures can rapidly cause a lot of damage in any organic substance. Cooking methods have developed further over the course of time. Appropriate equipment is therefore available for each cooking method. Through the new appliances and cooking techniques (sous vide), new possibilities for reducing the cooking shrinkage have opened up. This loss is absorbed or reduced as far as possible with tumbling.

In principle, raw meat contains a very regular structure. Three layers of connective tissue additionally encase muscle, muscle fascicles and muscle fibres. Raw meat has high elasticity and strength with the result that meat is difficult to cut through when biting into it. The highly regular structure also allows substances such as salt etc. to penetrate only with difficulty. In addition, penetration is also opposed by the lipid bilayer of the cell membranes which does dissolve slowly but is still present.

Chopping, cutting up, crushing, shredding and mincing destroy this regular structure. Through chopping (larger surface area), both the cooking shrinkage and the contamination of the pieces of meat is quicker. Through introduction of the marinade according to the invention with an oxidants content of from 5% to 15% into a tumbler, the cooking shrinkage as well as the shelf life can be positively influenced. At the same time, it was established that drying out the surface before the browning can reduce the cooking shrinkage. The best results are achieved with the following technique:

First of all, the pieces of meat should be as dry as possible on the outside. In addition, it is advantageous if the meat lies on a rack in the cold store at 3° to 5° Celsius over night.

Then, the meat is removed and distributed evenly on a greased roasting tray or on a roasting line and browned on all sides at 220° to 300° Celsius for 3-5 minutes. With this browning technique, the cooking shrinkage remains significantly lower (2.5% to 4%) than with conventional applications.

Subsequently, the browned meat is sealed with 90% vacuum into vacuum packs or vacuum-packed trays, which are provided with a lid. The packs or trays with the meat are then cooked in a water bath or with steam at 58° to 75° Celsius for a long time. This cooking method has the advantage that the meat does not come into contact with water. There is thereby no loss of flavour and there is no reduction in quality. Through the low-temperature cooking over a longer period and the use of the phosphate-free marinade according to the invention, the quality of the meat and the regenerability of pre-cooked meat meals chilled to 5° Celsius could be significantly improved.

1. Concentrated fruit juice for a marinade for tumbling a meat product, the proportion of sorbitol in the concentrated fruit juice being more than 10 wt.-%, wherein the concentrated fruit juice contains at least a concentrated pear juice, a concentrated mirabelle plum juice and/or a concentrated quince juice.

2. The concentrated fruit juice according to claim 1, wherein the concentrated fruit juice contains at least two of the concentrates concentrated pear juice, concentrated mirabelle plum juice and concentrated quince juice.

3. The concentrated fruit juice according to claim 1, wherein the concentrated fruit juice contains a mixture of concentrated pear juice, concentrated mirabelle plum juice and concentrated quince juice.

4. The concentrated fruit juice according to claim 3, wherein the concentrated fruit juice consists of up to at least 75%, preferably up to at least 90% of a mixture of concentrated pear juice, concentrated mirabelle plum juice and concentrated quince juice.

5. The concentrated fruit juice according to claim 3, wherein the concentrated fruit juice consists of up to 100% of a mixture of concentrated pear juice, concentrated mirabelle plum juice and concentrated quince juice.

6. The concentrated fruit juice according to claim 1, wherein the proportion of at least one, preferably two, particularly preferably all three of the concentrates concentrated pear juice, concentrated mirabelle plum juice and concentrated quince juice in the concentrated fruit juice is more than 20 wt.-%.

7. The concentrated fruit juice according to claim 1, wherein the proportion of concentrated pear juice in the concentrated fruit juice is between 1 and 33.3 wt.-%, preferably between 10 and 30 wt.-%, particularly preferably is 26 wt.-%.

8. The concentrated fruit juice according to claim 1, wherein the proportion of concentrated mirabelle plum juice in the concentrated fruit juice is between 1 and 43.3 wt.-%, preferably between 15 and 42.5 wt.-%, particularly preferably is 41.4 wt.-%.

9. The concentrated fruit juice according to claim 1, wherein the proportion of concentrated quince juice in the concentrated fruit juice is between 1 and 40 wt.-%, preferably between 10 and 35 wt.-%, particularly preferably is 32.6 wt.-%.

10. The concentrated fruit juice according to claim 1, wherein the proportion of sorbitol in the concentrated fruit juice is more than 11 wt.-%, preferably between 12 and 14 wt.-%.

11. A process for producing a concentrated fruit juice according to claim 1, said process comprising the steps of:
Depositing a fruit pulp made of pears, mirabelle plums and/or quinces onto a base,
Evaporating the water contained in the fruit pulp until the concentrated fruit juice forms, preferably concentrated by at least 5-fold, and
Filling the concentrated fruit juice into containers.

12. Use of a concentrated fruit juice according to claim 1 in a marinade for tumbling a meat product.

13. A marinade for tumbling a meat product, with the ingredients water, salt, gelatine, milk-based ingredient, preferably cream, and concentrated fruit juice according to claim 1.

14. The marinade according to claim 13, wherein the proportion of concentrated fruit juice in the marinade is between 3 and 10 wt.-%, preferably between 5 and 8 wt.-%.

15. The marinade according to claim 13, wherein the marinade contains starch, preferably based on maize.

16. A process for producing a meat product by tumbling with the steps of:
Chopping up the meat into pieces of meat,
Introducing the chopped-up pieces of meat into a tumbling device,
Introducing a marinade according to claim 13 into the tumbling device with the chopped-up pieces of meat and
Tumbling the pieces of meat in the marinade by rotating the tumbling device.

17. A meat product with at least one piece of meat and a marinade according to claim 13 absorbed in the piece of meat.
